(19) United States
(12) Patent Application Publication
(10) Pub. No.: US 2023/0002149 A1
(43) Pub. Date: Jan. 5, 2023

(54) INNER COVERING FOR CONTAINERS

(71) Applicant: C&S PACKAGING SUPPLIER, S.L.U., Santa Perpetua de Mogoda (ES)

(72) Inventor: José María MORÉ GENESCA, Santa Perpètua de Mogoda (ES)

(21) Appl. No.: 17/525,387

(22) Filed: Nov. 12, 2021

(30) Foreign Application Priority Data
Jun. 30, 2021 (ES) U202131363

(51) Int. Cl. B65D 90/04; B65D 81/38

(52) U.S. Cl. CPC B65D 90/047; B65D 81/3888; B65D 2313/04; B65D 2313/02; B65D 2313/10; B65D 2590/043

(57) ABSTRACT

The invention relates to inner covering for containers, the objective of which is to reduce the impact of temperatures on the inside thereof and to protect against the moisture known as “container rain”. The covering is formed by a rectangular prismatic case (1) in the horizontal position, made from a laminated composite having several layers, with two smaller bases and a series of bars (4) arranged in fixing elements (3) corresponding to two or more edges of the smaller bases, characterized in that the bars (4) are formed by elements that can be inserted into one another.

### TECHNICAL FIELD

The present invention relates to an inner covering for containers, the objective of which is to reduce the impact of temperatures in the inside thereof and protect against the moisture known as “container rain”. It is a covering that is very easy to install and store, and it reduces the risk of becoming accidentally disassembled during transport.

The present invention is applicable in the field of transport.

### PRIOR ART

Devices for covering and insulating the inside of cargo containers, such as the one disclosed in ES1194284U, are known in the state of the art. This system is based on a case and a series of assembly bars. These bars are telescopic and allow for a more compact, manageable, and standard assembly for logistics, which enables transporting more units.

The applicant does not know of other solutions similar to the invention.

### BRIEF EXPLANATION OF THE INVENTION

The invention consists of an inner covering for containers, according to the claims. Its various embodiments solve the problems in the state of the art.

This covering is formed by a rectangular prismatic case in the horizontal position, i.e., the smaller bases of which are on a side, and a series of support bars arranged in fixing elements corresponding to two edges of the smaller bases of the case. The bars are formed by elements that can be inserted into one another, such that in order to disassemble the bar one segment of an element must be pulled out of the adjacent one. To facilitate the rapid connection, each segment has a color or sign which indicates the support bar to which it belongs. Furthermore, the fixing elements in the case can have complementary colors or signs in order to quickly recognize where each bar must be placed.

This bar thus formed has a length that cannot be accidentally shortened when it is positioned in the container. Furthermore, standard containers have respective facing gaps with a perimetral flange in the upper corners where the bar is positioned after being somewhat forced. This means that the bar cannot accidentally surpass that flange, therefore the fixing thereof is entirely secure.

The case is made from an insulating, leak-tight material, such as a case obtained from a laminated composite having several layers: a layer of metallized polyester (PET MET), heat-sealed with a sheet of low-density polyethylene (LDPE) to another layer of high-density polyethylene (HDPE), in turn heat-sealed by means of LDPE to an outer layer of aluminium.

The case can also be adapted to the shape of the container by means of magnets for fixing to the wall and ceiling.

Other variants will be described below and defined in the dependent claims.

### DESCRIPTION OF THE DRAWINGS

To better understand the invention, the following figures are included.

FIG. 1 shows a schematical front view of an embodiment.

FIG. 2 shows a perspective view of the case with three bars, according to a preferred embodiment.

### EMBODIMENTS OF THE INVENTION

An embodiment of the invention will be very briefly described below as an illustrative and non-limiting example thereof.

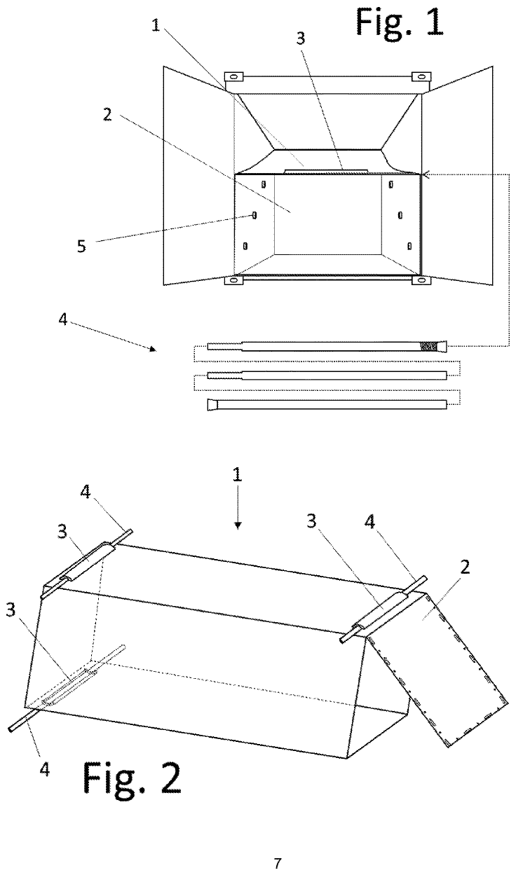

FIG. 1 shows an embodiment. It can be seen that the covering is formed by a rectangular prismatic case (1) in the horizontal position, the dimensions of which correspond to the inside of the container. It comprises one or more doors (2), which also correspond to the position of the corresponding doors of the container. In standard containers, the doors (2) are arranged at the smaller bases of the prism. The doors (2) comprise perimetral closures such as adhesive strips, Velcro strips, or optional zippers covered with flaps on both sides, which aid in insulation, etc.

The doors (2) are preferably formed by a rolled-up door of the same material as the case (1).

Respective linear fixing elements (3) run along two facing edges of one of the smaller bases of the prism and at least one edge of the other base. The fixing elements (3) can be bags running along the entire width and open at both ends, this being the most advantageous solution, or a series of rings. Respective bars (4) formed by elements that can be inserted into or coupled to one another and ending in rubber stoppers can be arranged in the upper fixing elements (3) of each base. This way of making the bars (4) prevents the dropping of the case (1).

The bar (4) can be finished, at least on one side, with a stop assembled on a spring with a high Young's modulus. It is thereby possible to slightly compress the length of the bar (4) against a high force that cannot occur accidentally.

The fixing element (3) of the lower part of the smaller base of the bottom of the case (1) primarily has a ballasting function, therefore it can be shorter.

The covering also comprises a series of magnets (5) which can be placed at different points of the case (1) in order to attach it to the wall or ceiling of the container. The number of magnets (5) depends on the size of the container.

1. An inner covering for containers, formed by a rectangular prismatic case (1) in the horizontal position, with two smaller bases and a series of bars (4) arranged in fixing elements (3) corresponding to two or more edges of the smaller bases, characterized in that the bars (4) are formed by elements that can be inserted into one another.

2. The inner covering for containers according to claim 1, characterized in that it comprises magnets (5) for fixing to the wall and ceiling.

3. The inner covering for containers according to claim 1, characterized in that the case (1) is made from a laminated composite having several layers: a layer of metallized polyester (PET MET), heat-sealed with a sheet of low-density polyethylene (LDPE) to another layer of high-density polyethylene (HDPE), in turn heat-sealed by means of LDPE to an outer layer of aluminium.

4. The inner covering for containers according to claim 3, characterized in that the case (1) has one or more doors (2) comprising perimetral closures formed by adhesive strips, Velcro strips, or zippers covered with flaps.

5. The inner covering for containers according to claim 1, characterized in that the segments of the bars (4) have an identification color or sign, and the corresponding fixing element (3) has a complementary color or sign.
